(19) United States
(12) Patent Application Publication
(10) Pub. No.: US 2007/0231513 A1
(43) Pub. Date: Oct. 4, 2007

(54) Thermally Sensitive Recording Medium

(76) Inventors: Mizuho Shimoyama, Tokyo (JP); Kaoru Hamada, Tokyo (JP); Seiki Yoneshige, Tokyo (JP); Kenji Hirai, Tokyo (JP)

Correspondence Address: FLYNN THIEL BOUTELL & TANIS, P.C., 2026 RAMBLING ROAD, KALAMAZOO, MI, 49008-1631, US

(21) Appl. No.: 10/564,808

(22) PCT Filed: Jul. 16, 2004
(86) PCT No.: PCT/JP04/10529

§ 371 Date: Jan. 13, 2006

(30) Foreign Application Priority Data
Jul. 18, 2003 (JP) 2003-276741

(51) Int. Cl. B41M 5/30

(52) U.S. Cl. 428/32.75

(57) ABSTRACT

Provision of a thermally sensitive recording medium comprising an undercoating layer containing a pigment and a binder as main components and a thermally sensitive color developing layer containing colorless or pale colored basic leuco dye and a color developing agent which develops color by reacting with said basic leuco dye as main components on a substrate, wherein said undercoating layer contains a water-retention agent and a pigment whose oil absorbing capacity prescribed by JIS K 5105 is from 80 cc/100 g to 120 cc/100 g as a pigment, further solid concentration of a coating for the undercoating layer is from 25% to 45% and dynamic water-retention capacity, which is Water retention measured with AA-GWR, is 350 g/m² or less.

### FIELD OF THE INVENTION

The present invention relates to a thermally sensitive recording medium which utilize color developing reaction of a colorless basic leuco dye with a color developing agent.

### BACKGROUND OF THE INVENTION

In general, a thermally sensitive recording medium is prepared by pulverizing a colorless or pale colored basic leuco dye and a color developing agent to fine particles respectively, mixing these two fine particles with additives such as a binder, a filler, a sensitizer, a slipping agent or others and form a coating, then by coating the obtained coating on a substrate such as paper, synthetic paper or plastics. Prepared thermally sensitive recording medium develops color by instant chemical reaction by heating with a thermal head, a hot stamp, a thermal pen or laser and recorded image can be obtained. A thermally sensitive recording medium is widely applied in a facsimile, a printer of computer, a bending machine for ticket and a recorder of various measuring instrument. Recently, recording equipments are becoming to have more diversity and high quality and along with said tendency, high speed printing and high speed formation of image are becoming possible, and an excellent quality for recording density of a thermally sensitive recording medium is required. Further, along with diversibility of usage, performance of high quality recorded image is required in all regions from lower density to high density.

As a method to satisfy above mentioned requirements, a method to improve surface smoothness of a thermally sensitive recording medium by a super calendar is ordinary carried out, however, a printed image of sufficient quality can not always be obtained. Further, it is well known that the uniform coating of an undercoating layer is necessary for formation of high quality printed image, and a method to improve the smoothness of the undercoating layer, for example, using a super calendar is known. Still further, for the purpose to provide a thermally sensitive recording medium which is superior in dot reappearancibility, for example, a method to accumulate first and second intermediate layers is proposed in patent document 1.

Patent document 1; JP 2000-108518 publication

### DISCLOSURE OF THE INVENTION

However, by the method using a super calendar, porous feature of the undercoating layer is hurt by calendar pressure and adiabatic ability is lost, and the sensitivity is deteriorated. Further, a method to accumulate first intermediate layer and second intermediate layer is disadvantageous from a manufacturing view point, because process becomes more complicated. The object of the present invention is to provide a thermally sensitive recording medium characterizing to have high recording sensitivity and to be able to obtain high quality recorded image without causing above problems.

Above object can be accomplished by a thermally sensitive recording medium comprising an undercoating layer containing a pigment and a binder as main components and a thermally sensitive color developing layer containing colorless or pale colored basic leuco dye and a color developing agent which develops color by reacting with said basic leuco dye as main components on a substrate, wherein said undercoating layer contains a water-retention agent and a pigment whose oil absorbing capacity (JIS K 5105) is from 80 cc/100 g to 120 cc/100 g as a pigment, further solid concentration of a coating for the undercoating layer is from 25% to 45% and dynamic water-retention capacity (Water retention measured with AA-GWR) is 350 g/m² or less. And it is desirable to use sodium alginate as a water-retention agent to the thermally sensitive recording medium.

The present invention is made by finding out that the penetrating condition of a coating fluid at the coating process (hereinafter shortened as a coating) to a paper becomes an important factor for a coating aptitude and a quality. In particular, at a contact type coating system such as blade coating is characterized to push a coating in a paper, therefore by evaluating the penetrating condition of the coating into the paper at pressed condition, the coating aptitude of the coating can be known. Further the present invention is paying attention to a relationship between solid concentration and dynamic water-retention capacity (Water retention measured with AA-GWR) of a coating liquid for an undercoating layer, and it is important that the solid concentration is from 25% to 45% and dynamic water-retention capacity (Water retention measured with AA-GWR) is 350 g/m² or less.

### DESCRIPTION OF THE PREFERRED EMBODIMENT

The preferred embodiment of the present invention will be illustrated as follows.

An undercoating layer of the present invention contains a pigment and a binder as main components, and solid concentration of a coating liquid is from 25% to 45%, desirably from 30% to 40%, and dynamic water-retention capacity (Water retention measured with AA-GWR) of a coating liquid is 350 g/m² or less, desirably is 300 g/m² or less.

Dynamic water-retention capacity used in the present invention is one of the methods to evaluate characteristics of a coating which measures penetration of the coating to a paper at certain pressure and time and is indicated by g/m² unit. When this value is small, it means that a coating is hard to penetrate into a paper and more coating remains on the surface of a paper, and coated quality becomes better. And when solid concentration of coating liquid is higher, water content is small and water-retention ability deteriorated so that the coating aptitude becomes bad, while, when concentration of coating liquid is lower, water content becomes large and water-retention ability becomes large, however, the viscosity of the coating liquid is deteriorated and the coating aptitude becomes bad. On the contrary, in the present invention, excellent coating aptitude can be obtained by maintaining concentration of a coating liquid in a range from 25% to 45% and dynamic water-retention capacity (Water retention measured with AA-GWR) to 350 g/m² or less. Wherein, dynamic water-retention capacity (Water retention measured with AA-GWR) of the present invention is measured in the condition of 23° C. temperature, 0.5 MPa pressure, for 40 minutes and 20 ml of liquid quantity using 1 sheet of filter paper.

Solid concentration and dynamic water-retention capacity of a coating liquid can be adjusted by kinds and adding quantity of a binder such as starch, polyvinylalcohol or carboxymethylcellulose, however, viscosity under high shearing speed can be easily elevated and a coating aptitude and quality changes. Therefore, the addition of a water-retention agent is most effective.

A kind of a water-retention agent is not particularly restricted, and it is possible to adjust the features of water-retention ability or viscosity to the aptitude region of the present invention by properly controlling the adding amount. As a water-retention agent, an acrylic or an urethane synthetic water-retention agent, or sodium alginate can be mentioned. Especially, when sodium alginate is contained, good water-retention ability can be obtained by small adding quantity, and by suppressing the penetration of a coating a thermally sensitive recording medium which is excellent in recording sensitivity and has good quality of image can be obtained. Further, among sodium alginates, the use of higher viscosity one is more desirable. In a case of sodium alginate of lower viscosity, it is necessary to add large quantity to perform a good water-retention ability, however, use of large quantity has a tendency to deteriorate a recording sensitivity. In the present invention, sodium alginate whose Brookfield viscosity (B viscosity) of 1% aqueous solution at 25° C. is 100 mPa·s or more is desirable, preferably 500 mPa·s or more is more desirable.

Further, it is desirable to use a water-retention agent by 0.01-1 weight parts to 100 weight parts of a pigment. A water-retention agent to be used in the present invention is considered to have an effect to improve water-retention ability of a coating liquid and to prevent the penetration of a coating. When the blending parts of the water-retention agent is too small, sufficient water-retention ability can not be obtained, and when the blending parts is too large, coating work becomes impossible because viscosity becomes too high. Accordingly, in the present invention, it is desirable to contain 0.01-1 weight parts of the water-retention agent, especially sodium alginate to 100 weight parts of the pigment. More desirable amount is 0.01-0.8 weight parts to 100 weight parts of the pigment, Furthermore desirable amount is 0.01-0.6 weight parts

In the present invention, the reason why the excellent effect can be obtained is considered as follows. As one reason why quality of printed image deteriorates, low concentration of solid part of a coating liquid for an undercoat layer in a thermally sensitive recording medium can be mentioned. Although depending on materials to be used aiming to obtain good quality or dispersability of a coating, compared with a case that the solid concentration of a coating for a coated layer of ordinary coating paper for printing is 60-70%, sometimes the solid concentration of the coating for an undercoating layer is set to be approximately 40% or less. In said case, a binder component has a tendency to migrate (transfer) easily to lower part, accordingly, distribution of the binder and orientation of the pigment in the coated layer become uneven. And when a thermally sensitive recording layer is formed on it, thermal energy is not transmitted uniformly and causes uneven problem of dot, therefore, the quality of recorded image is deteriorated. On the contrary, in the present invention, by blending a water-retention agent, especially, sodium alginate to a coating, improvement of water-retention ability and fluidity can be expected, accordingly migration of a binder is prevented and an uniform-coated layer can be obtained.

In the undercoating layer of the present invention, starch and derivatives, modified starch and derivatives, polyvinylalcohol and derivatives, modified polyvinyl alcohol and derivatives, methylcellulose, carboxymethylcellulose, water soluble polymer such as styrene·maleic anhydride, emulsion of synthetic resin such as styrene·butadiene copolymer, acrylic acid copolymer, urethane resin or vinyl acetate can be added.

Formation of an undercoating layer can be easily carried out by coating a coating liquid over a substrate such as paper, reclaimed paper, plastic film or synthetic paper using ordinary coating machine by 1-15 g/m² coating amount. As a coating method, air knife method, blade method, gravure method, roll coater method or curtain method can be mentioned and any kind of method can be used, however, from the view point that coating by high concentration is possible and a coating liquid does not penetrate easily into a substrate and uniform layer can be formed, it is desirable to form an undercoating layer by a blade coater method.

As a pigment to be contained in the undercoating layer, a pigment whose oil absorbing capacity (JIS K 5105) is from 80 cc/100 g to 120 cc/100 g is preferably used and not restricted, however, as a kind, clay (kaolin), calcined clay (calcined kaolin), calcium carbonate, aluminum oxide, titanium dioxide, magnesium carbonate, amorphous silica or colloidal silica can be mentioned. In particular, calcined clay is most desirable, because a thermally sensitive recording medium which is well-balanced in recording sensitivity and quality of image can be obtained. By using the calcined clay, it is considered that sufficient adiabatic effect is provided and sensitivity is improved, further, since a binder is not absorbed by a pigment so much, uniform coated layer is formed and excellent quality of image can be obtained. In the meanwhile, when calcined clay is used, since shape of calcined clay is flat, fluidity of a coating is generally inferior compared with a coating containing calcium carbonate or others whose shape is spherical, further, since OH group (hydroxyl group) of silanol does not exist on the surface because it is calcined, bonding with water becomes weak and have a tendency to deteriorate water-retention ability of a coating liquid.

On the contrary, in the present invention, by the effect of a water-retention agent, in particular, sodium alginate, in a case when calcined clay is used, coating aptitude is improved. Compared with polyvinylalcohol or carboxy methylcellulose, sodium alginate is superior in adhesive uniformity of solution. Therefore, protective colloid function becomes large and it is considered that this characteristic acts effectively. To a coating liquid for undercoating layer, dispersing agent, wax, thicker, surfactant, UV absorbing agent, antioxidant, water repellent agent or oil repellent agent can be added when a need is arisen.

It is desirable that Brookfield viscosity (B viscosity) of a coating liquid for undercoating layer at 25° C. is 200-1500 mPa·s. Further, it is desirable that the viscosity at shearing speed of 4.0×10⁻⁵ sec⁻¹-8.0×10⁻⁵ sec⁻¹ at 25° C. (high shear viscosity) is 20-100 mPa·s, more desirably is 30-50 mPa·s. Said B viscosity is a viscosity corresponding to shear when a coating liquid is supplied to a substrate by an applicator, while said high shear viscosity is a viscosity corresponding to shear when a coating is scraped off from a substrate by a scraper.

When a coating liquid is supplied to a substrate by an applicator, if the coating does not have adequate viscosity, the uniform supply of the coating liquid becomes difficult. For example, in a case when viscosity of the coating is too low, a problem that necessary coating amount can not be obtained is caused, because pick up amount of the coating liquid by an applicator roll becomes small. On the contrary, when viscosity of the coating liquid is too high, a problem may be caused in a pomp up process.

In general, regarding a blade coater method such as bar blade, the formation of stable (uniform) coated layer is not possible without adding pressure of a certain range. In the blade coater method, when pressure to scrape off a coating is too low, uniform scrape off of the coating is difficult and a uniform coated layer can not be formed, while when pressure to scrape off a coating is too high, a problem that a substrate is broken is caused. Therefore, in the blade coater method, when viscosity to the shear at the scraping off process is too small, the coating liquid is easily scraped off and necessary coating amount can not be obtained. In the meanwhile, when high shear viscosity is too high, it is difficult to scrape off the coating to the aimed coating amount.

On the contrary, in the present invention, by using a coating which indicates above viscosity, migration of the coating to a substrate is prevented and uniform coated layer with good covering ability is formed.

A thermally sensitive recording layer to be formed on an undercoating layer can be formed according to conventional well-known methods. As a colorless or pale colored basic leuco dye to be used to the thermally sensitive recording medium of the present invention, all public-known dyes which are well-known in conventional pressure sensitive or thermally sensitive recording paper field can be used and not restricted, however triphenylmethane compounds, fluorane compounds, fluorene compounds or divinyl compounds can be desirably used. Specific examples of a colorless or pale colored basic leuco dye are shown below. These compounds can be used alone or can be used together with.

<Triphenyl Methane Leuco Dye>

3,3′-bis(p-dimethylaminophenyl)-6-dimethylaminophthalide

[another name; Crystal Violet Lacton],
3,3-bis(p-dimethylaminophenyl)phthalide

[another name is Malachite Green Lactone]

<Fluorane Leuco Dyes>

3-diethylamino-6-methylfluorane
3-diethylamino-6-methyl-7-anilinofluorane
3-diethylamino-6-methyl-7-(o,p-dimethylanilino)fluorane
3-dibutylamino-6-methylfluorane
3-dibutylamino-6-methyl-7-anilinofluorane
3-dibutylamino-6-methyl-7-(o,p-dimethylanilino)fluorane
3-dibutylamino-6-methyl-7-(o-chloroanilino)fluorane
3-dibutylamino-6-methyl-7-(p-chloroanilino)fluorane
3-dibutylamino-6-methyl-7-(o-fluoroanilino)fluorane
3-n-dipentylamino-6-methyl-7-anilinofluorane
3-(N-ethyl-N-isoamylamino)-6-methyl-7-anilinofluorane
3-(N-ethyl-N-isoamylamino)-6-chloro-7-anilinofluorane
3-cyclohexylamino-6-chlorofluorane
   <Divinyl Leuco Dyes>
3,3-bis-[2-(p-dimethylaminophenyl)-2-(p-methoxyphenyl)ethenyl]-4,5,6,7-tetrabromo phthalide
3,3-bis-[2-(p-dimethylaminophenyl)-2-(p-methoxyphenyl)ethenyl]-4,5,6,7-tetrachloro phthalide
3,3-bis-[1,1-bis(4-pyrrolidinophenyl)ethylene-2-yl]-4,5,6,7-tetrabromophthalide
3,3-bis-[1-(4-methoxyphenyl)-1-(4-pyrrolidinophenyl)ethylene-2-yl]-4,5,6,7-tetra chlorophthalide
   <Others>
3-(4-diethylamino-2-ethoxyphenyl)-3-(1-ethyl-2-methylindol-3-yl)-4-azaphthalide
3-(4-diethylamino-2-ethoxyphenyl)-3-(1-octyl-2-methylindol-3-yl)-4-azaphthalide
3-(4-cyclohexylethylamino-2-methoxyphenyl)-3-(1-ethyl-2-methylindol-3-yl)-4-azaphthalide
3,3-bis(1-ethyl-2-methylindol-3-yl)phthalide
3,6-bis(diethylamino)fluorane-γ-(3′-nitro)anilinolactam
3,6-bis(diethylamino)fluorane-γ-(4′-nitro)anilinolactam
1,1-bis-[2′,2′,2″,2″-tetrakis-(p-dimethylaminophenyl)-ethenyl]-2,2-dinitrilethane
1,1-bis-[2′,2′,2″,2″-tetrakis-(p-dimethylaminophenyl)-ethenyl]-β-naphthoyl ethane
1,1-bis-[2′,2′,2″,2″-tetrakis-(p-dimethylaminophenyl)-ethenyl]-2,2-diacetylethane
bis-[2,2,2′,2′-tetrakis-(p-dimethylaminophenyl)-ethenyl]-methylmalonic acid dimethyl ester.

As a color developing agent to be used in the present invention, any kinds of public known color developing agent which makes a colorless or pale colored basic leuco dye develop color. As a specific example, for example, bisphenol A, 4-hydroxybenzoic acid esters, 4-hydroxyphthalic acid diesters, phthalic acid monoesters, bis-(hydroxyphenyl)sulfides, 4-hydroxy phenylarylsulfones, 4-hydroxyphenylarylsulfonates, 1,3-di[2-(hydroxyl phenyl)-2-propyl]-benzenes, 4-hydroxybenzoiloxy benzoic acid esters or bisphenolsulfones disclosed in JP H3-207688 publication or JP H5-24366 publication can be mentioned.

Further, in a thermally sensitive recording medium of the present invention, conventional sensitizer can be used likely to the conventional thermally sensitive recording medium. As the specific example of the sensitizer, fatty acid amide such as stearic acid amide or parmitic acid amide, ethylenebisamide, montan wax, polyethylene wax, 1,2-di(3-methylphenoxy)ethane, p-benzylbiphenyl, β-benzyloxynaphthalene, 4-biphenyl-p-tolyl ether, m-terphenyl, 1,2-diphenoxyethane, dibenzyl oxalate, di(p-chlorobenzyl)oxalate, di(p-methylbenzyl)oxalate, dibenzylterephthalate, benzyl p-benzyloxybenzoate, di-p-tolylcarbonate, phenyl-a-naphythylcarbonate, 1,4-diethoxynaphthalene, phenyl 1-hydroxy-2-naphthoate, 4-(m-methylphenoxymethyl)biphenyl, 4,4′-ethylenedioxy-bis-dibenzylbenzoate, dibenzoyloxymethane, 1,2-di(3-methylphenoxy)ethylene, bis[2-(4-methoxy-phenoxy)ethyl]ether, methyl p-nitrobenzoate or phenyl p-toluenesulfonate can be mentioned, however, not restricted to these compounds. These sensitizers can be used alone or can be used together with.

Further, as an image stabilizer which displays resistance effect to oil of recorded image,
4,4′-butylidene(6-t-butyl-3-methylphenol),
2,2′-di-t-butyl-5,5′-dimethyl-4,4′-sulfonyldiphenol,
1,1,3-tris(2-methyl-4-hydroxy-5-cyclohexylphenyl)butane or
1,1,3-tris(2-methyl-4-hydroxy-5-t-butylphenyl)butane can be added.

Still further, a releasing agent such as metal salt of fatty acid, a slipping agent such as waxes, an UV absorbing agent such as benzophenones or triazols, a water resistance agent such as gryoxal, a dispersing agent, a defoaming agent, an antioxidant or a fluorescent dye can be used.

Kinds and amount of components e.g. basic leuco dye, color developing agent or others to be used in the thermally sensitive recording medium of the present invention are decided according to required properties and recording aptitude and not restricted, however, in general, 0.5-10 parts of color developing agent and 0.5-10 parts of filler to 1 part of the basic leuco dye are used.

Basic leuco dye, color developing agent and other materials to be added by necessity are pulverized by a grinder such ball mill, attributer or sand grinder, or by means of an adequate emulsifying apparatus, until they are pulverized under several micron size, then add acrylic emulsion, colloidal silica and various additives according to the object, thus a coating is prepared. Coating amount of a thermally sensitive recording layer is not particularly restricted, however, preferably in the range of 2-12 g/m² by dry weight. The means for coating is not restricted and public known conventional methods can be used, for example, an off machine coater with various coater such as an air knife coater, a rod blade coater, a bill blade coater, a roll coater or a curtain coater or an on machine coater can be voluntarily chosen and used. Among these machines, a curtain coater process is desirable, because said process provides good printed image.

As one of the ground to deteriorate printed image, following reasoning can be mentioned. When a thermally sensitive recording layer is formed on an undercoating layer by a blade coating method, which is a generally used method, surface of the thermally sensitive recording layer becomes smooth by scraping action of a blade, however, surface of the undercoating layer is directly affected by uneven surface of a substrate paper and is not so smooth compared with the surface of the thermally sensitive recording layer. Consequently, the thickness of the thermally sensitive recording layer becomes unequal, and the existing quantity of color developing materials becomes different by position to position. Therefore, when thermal energy is loaded, degree of developed color becomes uneven, especially, in a case of high energy printing, developed color becomes deeper at thicker position and is difficult to obtain an excellent quality in a printed image. On the contrary, in a case of curtain coater method, a coating liquid is not scraped off and an outline coating is possible, that is, the thermally sensitive recording layer can be formed so as to go along with the outline of the undercoating layer. Therefore, the thickness of the thermally sensitive recording layer becomes even, so that the unevenness of printing density may be prevented and the printed image can be improved.

The thermally sensitive recording medium of the present invention can provide an over coating layer composed of polymer on the thermally sensitive recording layer for the purpose to improve preservability, or can provide an undercoating layer composed of polymer containing a filler under the thermally sensitive recording layer. On the opposite side of the substrate to the thermally sensitive layer, a back coat layer can be provided for the purpose to correct the curling of the medium. Further, various public-known technique in the field of thermally sensitive recording medium can be added, for example, to carry out smoothing treatment such as super calendar after coating process of each layers.

As a substrate of the thermally sensitive recording medium of the present invention, paper, recycled paper, synthetic paper, film, plastic film, plastic foam film or non-woven cloth can be properly selected and used according to an use. And a composite sheet which is prepared by combining these substrates can be used as a substrate.

### EXAMPLE

The thermally sensitive recording medium of the present invention will be illustrated more actually according to the Examples. In illustration, “parts” and “%” indicates “weight parts” and “weight %”.

Solutions, dispersions or coating liquids are prepared as follows.

### Example 1

Mixture of following blending ratio is stirred and dispersed, and coating liquids for an undercoating layer are prepared so as solid concentration and dynamic water-retention capacity to be as indicated in Table 1.

U Solution (Coating for Undercoating Layer)

Calcined clay (product of Engelhard Co., Ltd., commodity name; Ansilex

| | | |
|---|---|---|
| 90, <oil absorbing capacity 90 cc/100 g>) | 100 | parts |
| Styrene · butadiene copolymer latex (solid part 48%) | 40 | parts |
| 10% aqueous solution of polyvinylalcohol | 30 | parts |
| 2% aqueous solution of sodium alginate | 5 | parts |

(viscosity of 1% aqueous solution: 600-900 mPa · s, product of Kelco Co., Ltd., commodity name; Kelgin HV)

Obtained coating for an undercoating layer is coated to one surface of a substrate (paper of 60 g/m²) using a blade coater, then dried up and an undercoating layer of coating amount 10.0 g/m² is obtained.

Dispersions of following blending ratio for each materials for color developing agent (A solution) and basic leuco dye (B solution) are prepared, and are ground separately in wet condition by using a sand grinder to an average particle size of 1 μm.

A solution (dispersion of color developing agent)

| | | |
|---|---|---|
| 4-hydroxy-4′-isopropoxydiphenylsulfone | 6.0 | parts |
| 10% aqueous solution of polyvinyl alcohol | 18.8 | parts |
| water | 11.2 | parts |

B solution (dispersion of basic leuco dye)

| | | |
|---|---|---|
| 3-dibutylamino-6-methyl-7-anilinofluorane | 2.0 | parts |
| 10% aqueous solution of polyvinyl alcohol | 4.6 | parts |
| water | 2.6 | parts |

Then these dispersions are mixed by following ratio and a coating for recording layer is prepared

Coating liquid for a recording layer

| | | |
|---|---|---|
| A solution (dispersion of color developing agent) | 36.0 | parts |
| B solution (dispersion of basic leuco dye) | 9.2 | parts |
| Kaolin clay (50% dispersion) | 12.0 | parts |

Then the obtained coating liquid for recording layer is coated on the undercoating layer of said undercoated layer by a blade coater so as coating quantity to be 4 g/m² and dried up. This sheet is treated by a super calendar so as the smoothness to be 500-600 sec and a thermally sensitive recording medium is obtained.

### Example 2

By same process to Example 1 except coating the recording layer on the undercoating layer of said undercoating layer forming paper by a curtain coater instead of a blade coater a thermally sensitive recording medium is obtained.

### Example 3, Example 4

By same process to Example 1 except adjusting solid concentration and dynamic water-retention capacity of the coating for undercoating layer as shown in Table 1, a thermally sensitive recording medium is obtained.

### Example 5

By same process to Example 1 except changing blending ratio of 2% aqueous solution of sodium alginate of U solution (coating for undercoating layer) to 2.5 parts, a thermally sensitive recording medium is obtained.

### Example 6

By same process to Example 1 except changing blending ratio of 2% aqueous solution of sodium alginate of U solution (coating for undercoating layer) to 60 parts, a thermally sensitive recording medium is obtained.

### Comparative Example 1

By same process to Example 1 except not blending 2% aqueous solution of sodium alginate in preparation of U solution (coating for undercoating layer), a thermally sensitive recording medium is obtained.

### Comparative Example 2, Comparative Example 3

By same process to Example 1 except adjusting solid concentration and dynamic water-retention capacity of the coating for undercoating layer as to shown in Table 2, a thermally sensitive recording medium is obtained.

In Comparative Example 2, sodium alginate whose viscosity of 1% aqueous solution is 40-80 mPa·s (product of Kelco Co., Ltd., commodity name; Kelgin LV) is used as sodium alginate.

Further, in Comparative Example 3, precipitated calcium carbonate (product of Shiraishi Kogyo Co., Ltd., commodity name; Brilliant 15, oil absorbing capacity is 43 cc/100 g) is used.

<Evaluation of Color Developing Sensitivity>

Prepared specimens of thermally sensitive recording medium are subjected to printing at an applied energy of 0.344 mJ/dot by using TH-PMD (printing test machine for thermally sensitive recording paper, thermal head of Kyocera Co., Ltd is installed) product of Okura Denki Co., Ltd. Image densities of recorded part are measured and evaluated by using a Macbeth Densitometer (RD-18i).

<Evaluation of Printed Image>

Printed part is evaluated by visual inspection.

◯: white spots is not observed

Δ: white spots are observed

x: many spots are observed

<Evaluation of Coating Aptitude>

The coating rnnability and the obtained coated surface are evaluated.

◯: coating can be done without any problem, and the condition of coated surface by visual inspection is good.

Δ: coating can be done without big problem, however, sometimes, problem like streak or stain of a roller are observed, and long term stable coating is difficult.

x: coating defects such as streak causes at the coating process and stable coating is impossible.

<Measuring Method of Dynamic Water-Retention Capacity>

Dynamic water-retention capacity is measured by Water Retention Meter, product of Kaltec Scientific Co., Ltd., using a specified film (filter) “AA-GWR Test Filters (KALTEC SCIENCE, Inc.), GWR420” and a filtering paper “Whatmans Chromatography 17”. When this value is small, it indicates high dynamic water-retention capacity and high water-retention ability of right under a blade, and defects such as streak are not caused easily on a coated surface.

TABLE 1

| | | Example | | | | | |
|---|---|---|---|---|---|---|---|
| | | No. | | | | | |
| | | 1 | 2 | 3 | 4 | 5 | 6 |
| undercoating | pigment | calcined clay | calcined clay | calcined clay | calcined clay | calcined clay | calcined clay |
| layer | water retention | sodium | sodium | sodium | sodium | sodium | sodium |
| | agent | alginate | alginate | alginate | alginate | alginate | alginate |
| | (name) | Kelgin HV | Kelgin HV | Kelgin HV | Kelgin HV | Kelgin HV | Kelgin HV |
| | contents * | 0.1 | 0.1 | 0.1 | 0.1 | 0.05 | 1.2 |
| | conc. of solid of | 38 | 38 | 35 | 32 | 38 | 38 |
| | a coating % | | | | | | |
| | dynamic | 280 | 280 | 323 | 342 | 330 | 270 |
| | water-retention | | | | | | |
| | capacity | | | | | | |
| | B viscosity | 1340 | 1340 | 580 | 340 | 960 | 1360 |
| | mPa · s | | | | | | |
| | high shear | 46 | 46 | 36 | 29 | 47 | 44 |
| | viscosity | | | | | | |
| | mPa · s | | | | | | |
| thermally | coating method | blade | curtain | blade | blade | blade | blade |
| sensitive | | | | | | | |
| layer | | | | | | | |
| quality | sensitivity | ◯ 1.33 | ◯ 1.34 | ◯ 1.33 | ◯ 1.32 | ◯ 1.32 | Δ 1.24 |
| | printed image | ◯ | ⊚ | ◯ | Δ | Δ | ◯ |
| coating | undercoating | ◯ | ◯ | ◯ | ◯ | ◯ | ◯ |
| aptitude | layer | | | | | | |

* parts (weight parts) to 100 weight parts to pigment

TABLE 2

| | | Comparative Example | | |
|---|---|---|---|---|
| | | No, | | |
| | | 1 | 2 | 3 |
| undercoating | pigment | calcined | calcined | calcined |
| layer | | clay | clay | clay |
| | water | no | sodium | sodium |
| | retention | | alginate | alginate |
| | agent | | Kelgin LV | Kelgin HV |
| | (name) | | 0.1 | 0.1 |
| | contents | | | |
| | conc. of | 38 | 38 | 38 |
| | solid of a | | | |
| | coating % | | | |
| | dynamic | 420 | 390 | 200 |
| | water- | | | |
| | retention | | | |
| | capacity | | | |
| | B viscosity | 750 | 880 | 560 |
| | mPa · s | | | |
| | high shear | 47 | 45 | 17 |
| | viscosity | | | |
| | mPa · s | | | |
| thermally | coating | blade | blade | blade |
| sensitive | method | | | |
| layer | | | | |
| quality | sensitivity | ◯ 1.35 | ◯ 1.32 | X 1.09 |
| | printed | X | X | Δ |
| | image | | | |
| coating | undercoating | Δ | Δ | ◯ |
| aptitude | layer | | | |

### INDUSTRIAL APPLICABILITY

According to the present invention, a thermally sensitive recording medium which has high recording sensitivity and superior in printing image can be obtained by containing a water-retention agent, in particular, sodium alginate in an undercoating layer.

1. A thermally sensitive recording medium comprising an undercoating layer containing a pigment and a binder as main components and a thermally sensitive color developing layer containing colorless or pale colored basic leuco dye and a color developing agent which develops color by reacting with said basic leuco dye as main components on a substrate, wherein said undercoating layer contains sodium alginate as a water-retention agent and a pigment whose oil absorbing capacity prescribed by JIS K 5105 is from 80 cc/100 g to 120 cc/100 g as a pigment, further solid concentration of a coating for the undercoating layer is from 25% to 45% and dynamic water-retention capacity, which is Water retention measured with AA-GWR, is 350 g/m² or less.

2. The thermally sensitive recording medium of claim 1, wherein the content of sodium alginate is 0.01 to 1 weight part to 100 parts of pigment.

3. (canceled)

4. The thermally sensitive recording medium of claim 1 wherein B viscosity of 1% aqueous solution of the sodium alginate is 100 mPa·s or more.

5. The thermally sensitive recording medium according to claim 1, wherein the pigment whose oil absorbing capacity prescribed by JIS K 5105 is from 80 cc/100 g to 120 cc/100 g is the calcined clay.

6. The thermally sensitive recording medium according to claim 1, wherein B viscosity at 25° C. of a coating for undercoating layer is 200-1500 mPa·s and viscosity at the shear rate of 4.0×10⁻¹⁵ sec⁻¹ to 8.0×10⁻⁵ sec⁻¹ at 25° C. of a coating for undercoating layer is 20-100 mPa·s.

7. The thermally sensitive recording medium according to claim 1, wherein the thermally sensitive recording layer is formed by a curtain coating method.

8. A method for preparation of a thermally sensitive recording medium comprising, forming an undercoating layer containing a pigment and a binder as main components and a thermally sensitive color developing layer containing colorless or pale colored basic leuco dye and a color developing agent which develops color by reacting with said basic leuco dye as main components on a substrate, wherein said undercoating layer contains sodium alginate as a water-retention agent and a pigment whose oil absorbing capacity prescribed by JIS K 5105 is from 80 cc/100 g to 120 cc/100 g as a pigment, further solid concentration of a coating for the undercoating layer is from 25% to 45% and dynamic water-retention capacity, which is Water retention measured with AA-GWR, is 350 g/m² or less.

9. The thermally sensitive recording medium according to claim 1, wherein solid concentration of the coating for the undercoating layer is from 25% to 45% and dynamic water-retention capacity, which is Water retention measured with AA-GWR, is 350 g/m² or less.
